(19) United States
(12) Patent Application Publication
(10) Pub. No.: US 2002/0198662 A1
(43) Pub. Date: Dec. 26, 2002

(54) Device for measuring human body-adipose

(76) Inventor: Chih-Yuh Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/884,126

(22) Filed: Jun. 20, 2001

(51) Int. Cl. G06F 19/00

(52) U.S. Cl. 702/19

(57) ABSTRACT

A device for measuring a man's body-adipose includes two pairs of electrodes. Two contacting points of the two pairs of electrodes are formed into four circuits. The resistances measured out are input in a CPU for operation and the resistances measured between fingers of two hands are eliminated by the CPU so that the resistance of one's body is not affected by different conditions of a man's fingers, dry or damp degrees, rough or smooth degrees and large or small contacting dimensions, thus, possible to get a correct body resistance and accordingly to measure out an accurate value of a man's body adipose.

### BACKGROUND OF THE INVENTION

This invention relates to a device for measuring human body-adipose, particularly to one having four contacting points formed by measuring electrodes in circuits to accurately measure human body's resistances by means of calculating formulas in a CPU, regardless of different conditions of a man's fingers, dry or damp degrees, rough or smooth degrees and various contacting dimensions.

In accordance with many medical experimenting reports, the amount of a man's body-adipose absolutely and directly has much to do with his health, especially in respect of heart blood vessels. Formerly, we know about a man whether he is over fat or not merely judging with eyes, impossible to get a comparatively definite amount of his body-adipose.

In recent years, a device capable to measure the amount of a man's body-adipose has been already researched and developed. In a Taiwan Patent No. 366277 titled “Measuring Device of Body Adipose”, it includes two pairs of electrodes. When fingers of two hands contact the two pairs of electrodes, one pair of the electrodes will form a current circuit passing through an electrode (1a) and the other pair of the electrodes will form another current circuit passing through another electrode (2a) and a user's body, as shown in FIG. 7. Then voltage measuring is carried on by utilizing the measuring electrode (1b) of the pair of the electrode and the measuring electrode (2b) of the other pair, measuring out the change of the voltage and acquiring its resistance by the current gradually becoming weaker in the aforesaid circuit. And then this resistance value is transmitted to the CPU to be calculated by operational formulas and then the CPU calculates out the value of the user's body-adipose.

However, this conventional way of measuring a man's body-adipose is not perfect in practical use because the measured value of body-adipose will be affected by the degrees of dryness or dampness, or roughness or smoothness of a user's fingers and also by the contacting dimensions between the fingers and the electrodes. Most likely, the body adipose measured out is quite different from a real one.

### SUMMARY OF THE INVENTION

This invention is to offer a device for measuring a man's body-adipose, having two pairs of electrodes, with two contacting points of each pair of the electrodes functioning as measuring electrodes in circuits, together forming four circuits among these electrodes. Then, through test operation of the CPU, the resistances produced between fingers will be deleted to prevent the body resistance from being affected by various conditions, dry or damp degrees, rough or smooth degrees of a user's fingers and their contacting dimensions so as to get a correct body resistance and measure out an accurate value of a man's body adipose.

### BRIEF DESCRIPION OF THE DRAWINGS

This invention will be better understood by referring to the accompanying drawings, wherein:

FIG. 1 is an upper view of a first embodiment of a device for measuring body-adipose of the present invention.

FIG. 2 is a lower view of the device for measuring body-adipose of the present invention.

FIG. 3 is a diagram of a circuit of the first embodiment of the device for measuring body-adipose of the present invention.

FIG. 4 is a block diagram of a whole structure of the device for measuring body-adipose of the present invention.

FIG. 5 is a diagram of a circuit of a second embodiment of a device for measuring body-adipose of the present invention.

FIG. 6 is a perspective view of a third embodiment of a device for measuring body-adipose of the present invention.

FIG. 7 is a diagram of a circuit of contacting points of a conventional device for measuring body-adipose.

### DETAILED DESCRIPION OF THE PREFERRED EMBODIMENTS

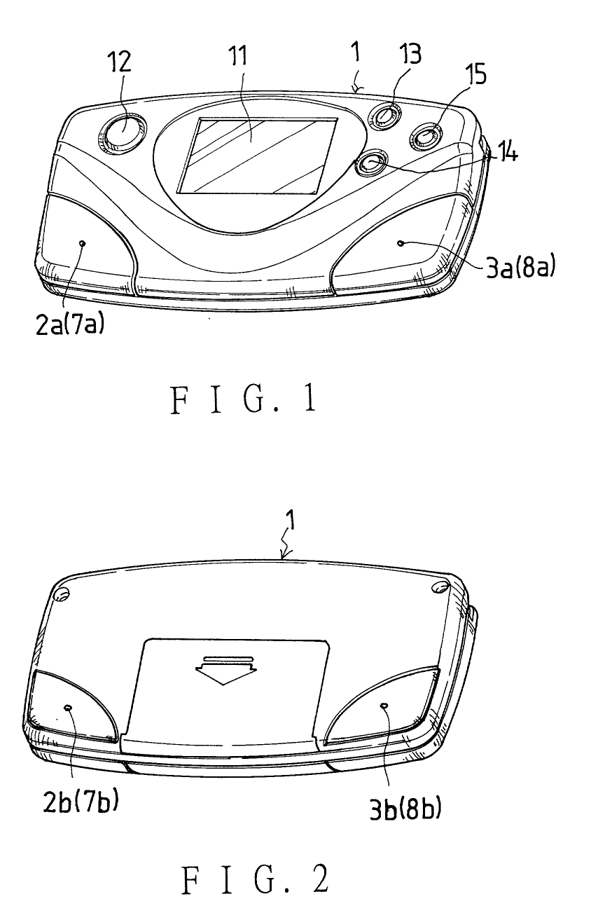

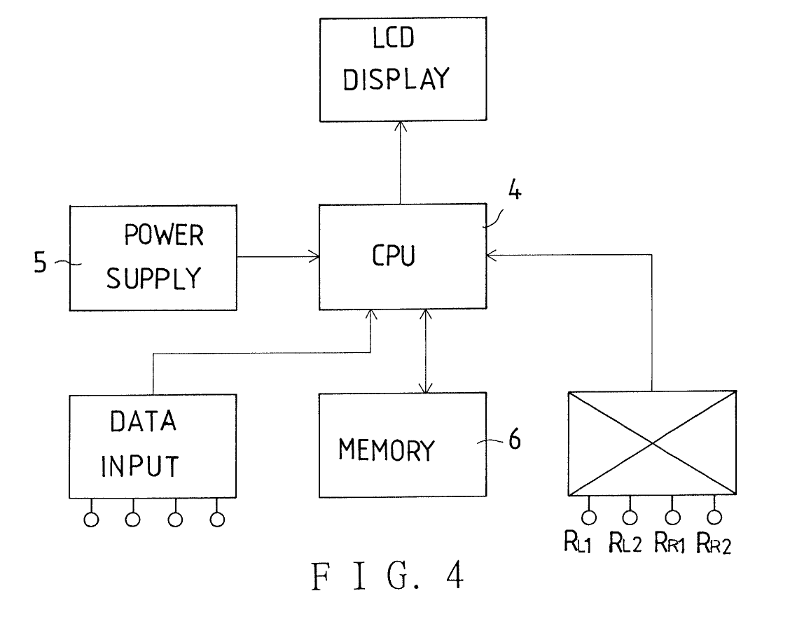

A preferred embodiment of a device for measuring a man's body-adipose in this invention, as shown in FIGS. 1, 2 and 4, includes a housing 1, an LCD display 11 provided on an upper surface of the housing 1, a CPU 4 mounted in the housing and connected with the display 11, a power switch 12, an upper adjusting key 13, a lower adjusting key 14 and a setting mode optional key 15 all provided on both sides of the LCD display 11. The power switch 12 turns on or turn off power to control a power supply 5 to furnish the CPU 4 with power and put in the related data of a man's height, weight and the like in a memory 6 contained in the CPU 4 by means of the setting mode optional key 15, the upper adjusting key 13 and the lower adjusting key 14.

Next, two pairs of electrodes 2 and 3 are fixed at proper positions in the housing 1 and two electrodes (2a), (2b) of the left pair of the electrodes 2 and the other two electrodes (3a), (3b) of the right pair of the electrodes 3 function as measuring electrodes in their circuits.

Thus, when a user's thumbs and other fingers (like index-fingers) contact respectively the electrodes (2a), (2b), (3a), (3b) of the two pairs of the electrodes 2 and 3, the resistances between the fingers and these electrodes and the resistance between the fingers and the body and the electrodes can be measured out and sent to the CPU 4 to let it carry on test calculating based on a programmed operational procedure.

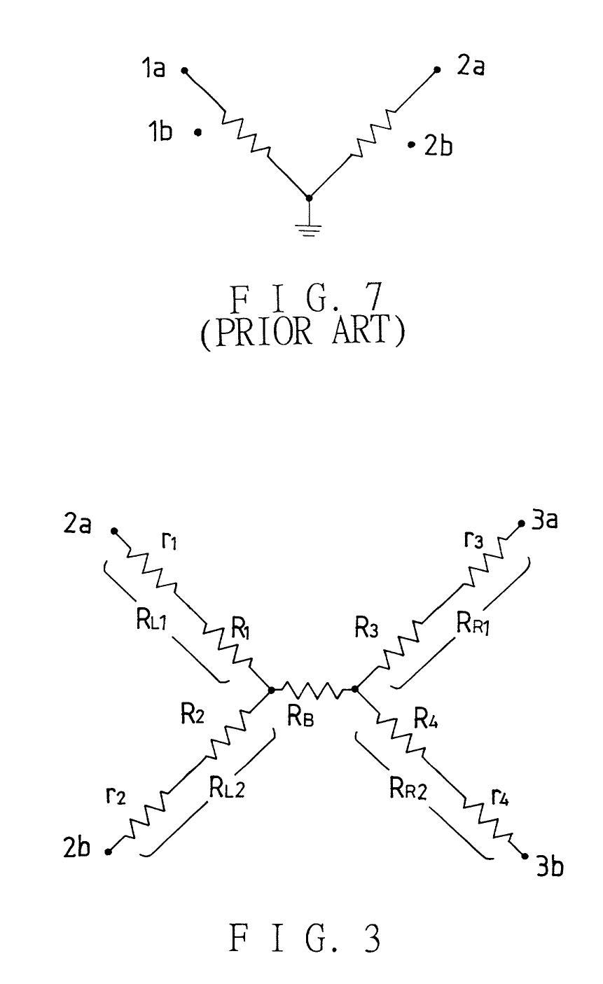

FIG. 3 shows the measured resistances diagrammed. The contacting small resistance between the thumb of a left hand and the electrode (2a) is r₁, the resistance of the thumb is R₁, the contacting small resistance between another finger of the left hand and the electrode (2b) is r₂ and the resistance of the other fingers is R₂. As for the right hand, the contacting small resistance between the thumb and the electrode (3a) is r₃, the resistance of the thumb is R₃, the contacting small resistance between the other fingers and the electrode (3b) is r₄, the resistance of other fingers is R₄, and the resistance of the body is called R_{B}.

Then the resistance r₁ and R₁ are connected in series to form a resistance R_{L1}, the resistance r₂and R₂are connected in series form an R_{L2}, the resistance r₃ and R₃ are connected in series to form R_{R1} and the resistances r₄ and R₄ are connected in series to form an R_{R2}. Thus, a first circuit is formed between the electrodes (2a) and (2b) via the thumb and another finger of the left hand, a second circuit formed between the thumb and the other fingers of the right hand, a third circuit is formed between the electrodes (2a) and (3b) via the thumb of the left hand, the body and the other finger of the right hand, and a fourth circuit formed between the electrodes (2b) and (3a) through the other finger of the left hand, the body and the thumb of the right hand.

Based on the aforesaid four circuits, four formulas are got as follows.

r₁+R₁+r₂+R₂ (1)

r₃+R₃+r₄+R₄ (2)

r₁+R₁+R_{B}+r₄+R₄ (3)

r₂+R₂+R_{B}+r₃+R₃ (4)

The four formulas may be simplified as:

R_{L1}+R_{L2} (1)

R_{R1}+R_{R2} (2)

R_{L1}+R_{B}+R_{R2} (3)

R_{L2}+R_{B}+R_{R1} (4)

Then R_{B} can be got from a formula, {(3)+(4)−(1)−(2)}/2, that is,

{R_{L1}+R_{B}+R_{R2}+R_{L2}+R_{B}+R_{R1}−R_{L1}−R_{L2}−R_{R1}−R_{R2}}/2=2R_{B}/2=R_{B}.

To sum up, the measuring electrodes in this invention are formed by making use of the contacting points of the electrodes in the circuits to let them intersect with each other to form circuits among the electrodes (2a), (2b), (3a), (3b) of the two pairs of electrodes (2) and (3) and these measuring electrodes will transmit the resistances measured out to the CPU 4, which carries on calculating by means of the programmed operational formulas illustrated above, getting accurately a resistance value of the body, i.e. an R_{B} value, and then correctly figure out the body adipose.

In accordance with the designing pattern of the electrodes and the operational formulas of the CPU in this invention, the contacting small resistance produced by the fingers contacting with the electrodes and the resistance of the fingers can be eliminated, not affecting the R_{B} value of the body. In other words, different conditions of a man's fingers, dry or damp degrees, rough or smooth degrees will make the contacting small resistance and finger resistance changeable, but these resistances will be deleted or subtracted when they are put in the CPU for calculation and finally only the R_{B} value of the body is remained, thus getting a comparatively accurate RB value of a body.

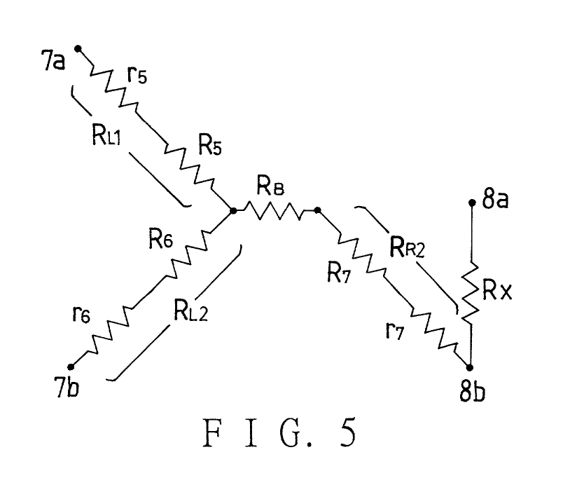

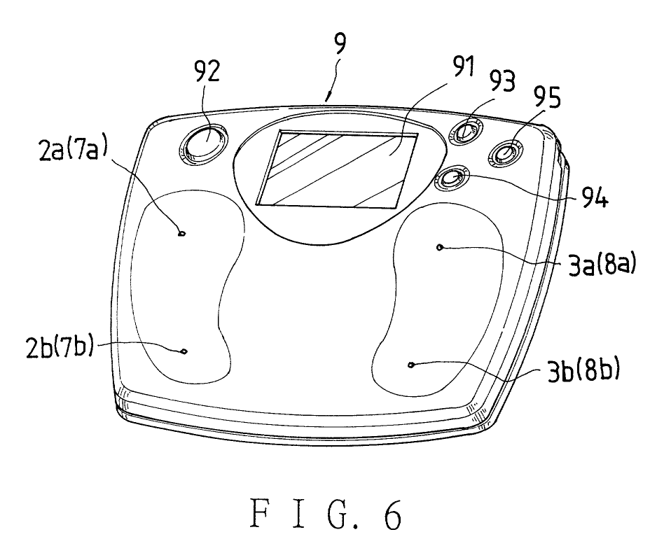

Another preferred embodiment of a device for measuring human body-adipose, referring to FIG. 5, includes a housing 1, two pairs of electrodes (7) and (8) in the housing 1 respectively having two electrodes (7a), (7b) and (8a), (8b), with a resistance Rx connected between the electrodes (8a) and (8b) to let the electrode (8a) formed into an unreal contacting point. When the thumbs and other finger (like index fingers) of two hands respectively contact the electrodes (7a), (7b), (8a), and (8b) of the two pairs of electrodes (7), and (8), resistances can be measured out between the fingers and the electrodes (7a), (7b) and (8b) and between the fingers and the body and the three electrodes.

In the diagram, the contacting resistance between the thumb of a left hand and the electrode (7a) is r₅, the resistance on the thumb of the left hand is R₅, the contacting small resistance between the other fingers of the left hand and the electrode (7b) is r₆ and the resistance on the other fingers of a left hand is R₆. As for the right hand, the contacting small resistance between the other fingers and the electrode (8b) is r₇, the resistance of the other fingers is R₇ and the resistance of the body is R_{B}. Then, the resistance r₅ and R₅ connect in series to form a resistance R_{L1}, the resistance r₆ and R₆ connect to form a resistance R_{L2}, and the resistance r₇ and R₇ connect to form a resistance R_{R2}.

Thus, a first circuit is formed between the electrodes (7a) and (7b) via the thumb and the other finger of the left hand, a second circuit formed between the electrodes (8a) and (8b) and the thumb and the other finger of the right hand, a third circuit formed between the electrodes (7a) and (8b) via the thumb of the left hand, the body and the other finger of the right hand and finally a fourth circuit formed between the electrodes (7b) and (8a) and the other finger of the left hand, the body and the other finger of the right hand and the thumb. According to the four circuits mentioned above, four formulas are got as follows.

r₅+R₅+r₂+R₂ (1)

r₅+R₅+R_{B}+r₇+R₇ (2)

r₆+R₆+R_{B}+r₇+R₇+Rx (3)

Rx (4)

The four formulas above may be simplified as follows:

R_{L1}+R_{L2} (1)

R_{L1}+R_{B}+R_{R2} (2)

R_{L2}+R_{B}+R_{R2}+Rx (3)

Rx (4)

Then a formula [(2)+(3)−(1)−(4)]/2 is formed to get a value of R_{B}+R_{R2}, that is, [R_{L1}+R_{B}+R_{R2}+R_{L2}+R_{B}+R_{R2}+Rx−R_{L1}−R_{L2}−Rx]/2=[2R_{B}+2R_{R2}]/2=R_{B}+R_{R2}

Additionally the R_{R2} value is preset in the CPU (4) and this preset R_{R2} value is subtracted from the above-mentioned operational formula (R_{B}+R_{R2}) to get a value of R_{B}.

Furthermore, the device for measuring human body-adipose of this invention can be made in a bathroom scale shape, as shown in FIG. 7. The housing 9 is provided with a LCD display 91 on an upper surface, a power switch 92, an upper adjusting key 93, a lower adjusting key 94 and a setting mode optional key 95 also on the upper surface. When a user stands on the body 9, user's weight data shown will be directly transmitted to the CPU 4 while the other related data incapable to be measured out have to be put in by the upper and the lower adjusting keys 93 and 94 as well as by the setting mode optional key 95. Thus, when any two points of the bottoms of two feet contact with the electrodes (2a), (2b), [(7a), (7b)], (3a), (3b), [(8a), (8b)], a circuit is formed to measure out the R_{B} value of the body and then acquire the value of body-adipose through the operation of the CPU.

What is claimed is:

1. A device for measuring human body-adipose comprising a housing provided with an input-key for putting-in related data, an LCD display fixed on an upper surface of said housing for showing said input data and a measured result, with said input data stored temporarily in a memory, four electrodes fixed in said housing, said four electrodes contacted respectively by a thumb and another finger of a left hand and by a thumb and another finger of a right hand, data obtained between said four electrodes and said thumbs and said other fingers transmitted to a CPU to carry on programmed operation;
characterized by said four electrodes functioning as measuring electrodes in circuits formed by said four electrodes and the fingers of two hands, said four electrodes formed into four circuits when the thumbs and the other fingers contact said electrodes, said four circuits including a first circuit (1) from the thumb to the other fingers of the left hand, a second circuit (2) from the thumb to the other finger of the right hand, a third circuit (3) from the thumb of said left hand through a body to the other fingers of said right hand 4, a fourth circuit (4) from the other finger of said left hand through said body to the thumb of said right hand, measured resistances putting in said CPU through said circuits for operation to get an accurate R_{B} value of a man's body, said CPU calculating out the user's body-adipose correctly.

2. A device for measuring human body-adipose comprising a housing provided with an input-key for putting-in related data, an LCD display fixed on an upper surface of said housing for showing the input data and a measured result, said input data temporarily stored in a memory, and four electrodes fixed in said housing, said four electrodes contacted respectively by a thumb and another finger of a left hand and by a thumb and another finger of a right hand, the data obtained between said thumbs and said other fingers and said electrodes, said data transmitted to a CPU to carry calculation;
characterized by one pair of said electrodes connected in series by a preset resistance Rx, one of said electrodes formed into an unreal contacting point and the other electrodes functioning as a measuring electrodes in their circuits, four circuits formed among said four electrodes when said two thumbs and said other fingers of two hands contacting respectively said electrodes, said four circuits including a first circuit (1) from a thumb to the other fingers of a left hand, a second circuit (2) from a thumb to another finger of a right hand, a third circuit (3) from the thumb through a body to the other finger of said right hand, fourth circuit (4) from another finger of the left hand through the body to the thumb of said right hand, the measured resistances by means of said four circuits put in said CPU for calculation to get an accurate R_{B} value of a man's body and then calculate correctly the body-adipose.

3. The device for measuring body-adipose as claimed in claim 1 or 2, wherein said device can be made in a bathroom scale shape for measuring an R_{B} value of a lower half portion of a user's body and then getting an accurate value of the user's body-adipose through the operation of said CPU.
